(19) United States
(12) Patent Application Publication
(10) Pub. No.: US 2013/0216662 A1
(43) Pub. Date: Aug. 22, 2013

(54) OLIVE-BASED RECONSTITUTED PRODUCT AND PRODUCTION PROCESS

(71) Applicants: Jorge GÓMEZ CARRETERO, Dos Hermanas (Seville) (ES); José Manuel SÁNCHEZ GIRALDEZ, Montellano (Seville) (ES); José Maria FERNÁNDEZ GINÉS, Ogijares (Granada) (ES); Juan Diego TORRES OQUENDO, Medellin (CO); Magdalena TUDELA CARRASCO, Cenes de la Vega (Granada) (ES)

(72) Inventors: Jorge GÓMEZ CARRETERO, Dos Hermanas (Seville) (ES); José Manuel SÁNCHEZ GIRALDEZ, Montellano (Seville) (ES); José Maria FERNÁNDEZ GINÉS, Ogijares (Granada) (ES); Juan Diego TORRES OQUENDO, Medellin (CO); Magdalena TUDELA CARRASCO, Cenes de la Vega (Granada) (ES)

(73) Assignee: GRUPO ANGEL CAMACHO, S.L., Moron de la Frontera (Seville) (ES)

(21) Appl. No.: 13/399,155

(22) Filed: Feb. 17, 2012

(51) Int. Cl. A23L 1/212; A23P 1/08; A23P 1/12; A23L 1/0532

(52) U.S. Cl. 426/102; 426/276; 426/250

(57) ABSTRACT

The present invention relates to the process of obtaining reconstituted foods from natural raw materials and the products obtained following said process. It relates particularly to the process of producing a reconstituted product comprising two concentrically distributed portions such that the outer portion comprises reconstituted olive and the inner portion comprises reconstituted pepper.

### FIELD OF THE INVENTION

The present invention belongs to the food industry field, particularly relating to a process for producing an olive and pepper-based reconstituted product and to the product obtained by means of said process.

### BACKGROUND OF THE INVENTION

There is a clear demand on the market for natural products the prior treatment of which preserves its organoleptic properties, particularly its flavour and colour, as closely as possible to the original state. Heat stable textured foods based on dehydrated natural raw materials are known. However, said starting raw material determines the final properties of the product obtained, distancing it from the characteristics of a natural product.

A product is known as a reconstituted product when it is sliced or ground and then creates, with or without other ingredients, a different structure which will provide a new appearance and a new texture, usually in an attempt to mimic the original natural product. A new generation of products called analogues, or substitutes mainly imitating seafood or other expensive products has been developed in the recent years, which have not only become popular among people of the Far East, but have also been widely accepted by the North Americans and more recently by the Europeans. In addition to these marine products, other products have been developed with different raw materials from plants and even cheese, the main application of which is for stuffing olives or batter-coated products for frying.

One of the greatest advantages of reconstituted products is the possibility of modifying the composition of the end product by means of reformulating the original product which has been previously sliced or ground. In this sense, the removal of constituents or the incorporation of other new ingredients or additives could be mentioned. From the technological point of view, these products, ingredients or additives, can be divided into those: a) which favour preservation, b) which are functional ingredients from the technological point of view and c) which are functional from the nutraceutical point of view. Some ingredients, such as the case of fibre, are able to perform more than one of these functions.

Olives are a product of great interest not only due to its flavour, but to its beneficial health properties, some derived from its carotenoid and antioxidant content, such as polyphenols. Likewise, pepper comprises several vitamins (B2, C, E), mineral salts (potassium, magnesium, phosphorus) and fibre, making it an important food to be included in the diet. There are pepper stuffed olives, however there is still a need for an alternative product to the natural pepper stuffed olive, particularly a product which is a sliced reconstituted product comprising both olive and pepper which maintain the organoleptic properties and has a texture similar to the pepper stuffed olive and which is a ready-to-use product that can be easily preserved and distributed.

### OBJECT OF THE INVENTION

The present invention relates to a process for producing a sliced reconstituted product comprising olive and pepper, characterised in that it comprises the following steps:
a) grinding the starting olive until obtaining a homogenous mass of ground olive,
b) adding water, alginate and guar gum to the ground olive of step a) and mixing until obtaining a homogenous mixture 1 (mixture 1),
c) adding alginate and guar gum to ground and strained natural pepper and mixing until obtaining a homogenous mixture 2 (mixture 2),
d) co-extruding mixtures 1 and 2 simultaneously, an outer tube of mixture 1 with the inner space stuffed with mixture 2 being obtained,
e) gelatinization of the stuffed tube obtained in step d) by means of calcium salt bath, and
f) slicing the gelatinized stuffed tube obtained in step e).

The present invention also relates to a sliced reconstituted food product comprising olive and pepper obtainable according to said process and to the use of said reconstituted product in the food industry, particularly in pizza toppings, salads, pastas, bakery products, pastry products, ready-cooked meals and snacks.

### BRIEF DESCRIPTION OF THE DRAWINGS

FIG. 1 shows a transversal section of a stuffed tube, of circular section, wherein mixture 1 (reconstituted olive, striped portion) surrounds in its interior a mixture 2 (reconstituted pepper, black portion).

### DETAILED DESCRIPTION OF THE INVENTION

The present invention relates, in a first aspect, to a process for producing a reconstituted product comprising olive and pepper, characterised in that it comprises the following steps:
a) grinding the starting olive until obtaining a homogenous mass of ground olive,
b) adding water, alginate and guar gum to the ground olive of step a) and mixing until obtaining a homogenous mixture 1 (mixture 1),
c) adding alginate and guar gum to ground and strained natural pepper, and mixing until obtaining a homogenous mixture 2 (mixture 2),
d) co-extruding mixtures 1 and 2 simultaneously, an outer tube of mixture 1 with the inner space stuffed with mixture 2 being obtained,
e) gelatinization of the stuffed tube obtained in step d) by means of calcium salt bath, and
f) slicing the gelatinized stuffed tube obtained in step e).

In the context of the present invention, starting olive is understood as a pitted fermented green olive (does not include discarded olive) with the following initial values: pH between 3.5-4.0; salt between 8-9° bé (degree Baumé); acidity between 0.8-0.9% expressed as lactic acid. These olives are desalted until reaching salt values between 1-2° bé; pH between 4-4.5; acidity around 0% expressed as lactic acid.

The proportion of olive, alginate (gelatinizating agent) and guar gum (thickening agent) in mixture 1 is modified until obtaining a product with the desired sensory characteristics, particularly that which maintains the organoleptic characteristics of the original product. In a particular embodiment, the content of starting olive is 60-75% by weight of mixture 1. The starting olive is ground by means known by the person skilled in the art and once a homogenous mass is obtained water, alginate, and guar gum are added. In a particular embodiment of step b), water between 20% and 30% by weight of mixture 1, alginate between 2% and 3% by weight of mixture 1, and guar gum between 0.3% and 0.5% by weight of mixture 1 are added. Said percentages of alginate and guar gum allow forming reticular structures capable of supporting the rest of the process. In a particular embodiment the water added is distilled or osmotic water which improves gelatinization. In another particular embodiment the alginate is sodium alginate. The added components are mixed with the homogenous mass of ground olive until obtaining a homogenous mixture 1 (mixture 1).

In a particular embodiment, in addition to water, alginate and guar gum a natural food colouring is added in step b) in a percentage between 0.05% and 0.5% by weight of mixture 1. In another particular embodiment, the colouring is added in a percentage between 0.05% and 0.2% by weight of mixture 1. The colouring is selected from the group consisting of green colourings M-41/10, M-42/10, M-51/10, M-52/10 and M-53/10. The addition of these colourings allows obtaining a product which is more similar to the natural olive.

The ground and strained natural pepper used is selected from the group consisting of red pepper, green pepper, jalapeno pepper and mixtures thereof, which can be commercially obtainable. Generally, commercial ground and strained natural pepper has a ° brix of around 10, a pH between 3.5-5; salt around 0° bé (it is desalted) and a citric acidity value around 0.5-1.30%.

The pH of each of the mixtures, mixture 1 and mixture 2, must be separately controlled such that it has a value greater than 4.6 and less than 5.5. If each mixture did not have a pH value comprised in said range, it would be adjusted by means known by the person skilled in the art, for example, by means of adding caustic soda. In a particular embodiment, the pH of each mixture is controlled so that it has values close to 5, which favours the correct gelatinization in step e) of the process of the invention.

The addition of alginate to both mixtures to be extruded makes the reconstituted products obtained thermostable, because the alginate presents, once the final polymeric structure is formed, thermostable properties. In other words, since the physical properties of the reconstituted product are not modified upon heating, the product can therefore be subjected to heating (boiling, baking, frying, pasteurising) or cooling (refrigerating, freezing) without loosing its organoleptic and mechanical properties. In a particular embodiment the added alginate is sodium alginate.

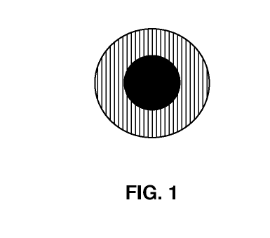

Once the pH of mixture 1 and 2 is adjusted, mixture 1 and mixture 2 are co-extruded simultaneously. An outer tube of a mixture with its inner space stuffed with the other mixture is obtained with the simultaneous co-extrusion of two different mixtures. In a particular embodiment, the cross-section of the tube is circular, thus a cylindrical tube wherein mixture 1 is on the outside and mixture 2 is in the inside is obtained (see FIG. 1). In a particular embodiment the diameter of the inner portion (mixture 2) is approximately half of the outer portion (mixture 1).

Once the stuffed tube having two materials is extruded (mixture 1 in the outer portion, mixture 2 in the inner portion), it is left to fall into a bath containing calcium salts, where the gelatinization will occur as the alginate comes into contact with the calcium (outer gelatinization). In this case, gelatinization will gradually occur from the outside to the inside, therefore the product must remain in the bath long enough so that the gelatinization of the inner most layers occurs. Calcium salt solutions at a concentration between 3-5% are used to prevent the quick gelatinization of surface layers which can lead to an inadequate product (hard surface and soft interior). In a particular embodiment the concentration of said calcium salt is 4%. In a particular embodiment, 4% calcium chloride is used as calcium salt. In another particular embodiment the gelatinization is carried out at a temperature between 30° C. and 50° C., which provides a great advantage since the gelatinization speed is greater than when it is performed at room temperature and does not cause a quick gelatinization with the drawbacks mentioned above.

Outer gelatinization is a production method which is less complicated than inner gelatinization, therefore in addition to providing good results in the process of the present invention, unlike inner gelatinization, the use of outer gelatinization leads to a saving in material, working time, logistic and technological requirements.

The stuffed tube of reconstituted product is then sliced, the thickness of the slices will depend on the specific application thereof. A reconstituted product with the appearance of pepper stuffed olive is thus obtained.

The salt values of the sliced reconstituted product is almost 0-1° bé therefore it is subjected to an equilibrium and salting process after slicing. To that end, the sliced reconstituted product is deposited in stock brine solution (salt values of 8-9° bé; pH between 3.5-4; lactic acidity 0.8-0.9%) until the product is packaged or frozen. In a particular embodiment, the packaging is performed in 4% brine. In another particular embodiment, the product is subjected to IQF freezing (Individual Quick Freezing). In another particular embodiment the reconstituted product is pasteurised.

A significant advantage of the design of the process of the present invention is that it allows its automation, phases such as the addition of the different components, mixing, slicing, pasteurising or packaging being able to be controlled.

In a second aspect the present invention relates to a sliced reconstituted food product comprising olive and pepper, hereinafter product of the invention, obtainable according to the process of the invention. In a particular embodiment, the product of the invention is used in the food industry, for example, in pizza toppings, salads, pastas, bakery products, pastry products, ready-cooked meals and snacks. In another particular embodiment, the sliced product is reconstituted green olive stuffed with reconstituted red pepper.

The product of the invention has the appearance and flavour of the starting product processed in a conventional manner, with the advantage that it does not lose said properties even after being packaged, heated, baked, fried, pasteurised, refrigerated or frozen.

A final aspect of the present invention relates to the use of the product of the invention in the food industry, particularly, for example, in pizza toppings, salads, pastas, bakery products, pastry products, ready-cooked meals and snacks.

### DESCRIPTION OF THE PREFERRED EMBODIMENT

### Example 1

### Reconstituted Green Olive and Red Pepper Product

To produce a reconstituted green olive and red pepper product, fermented green olives (74.80% by weight of mixture 1) with the following characteristics are used: salt 8.7° bé; pH 3.77; 0.75% lactic acidity. Said olives were desalted for 48 h and an olive with the following characteristics was obtained after that period: pH 4.04; salt 1.7° bé; lactic acidity 0.16%, which was ground until obtaining a homogenous mass. 22.35% by weight of distilled water, 2.5% by weight of sodium alginate, 0.30% by weight of guar gum and 0.05% of green colouring was added to said ground olive mass and it was mixed until obtaining a homogenous mixture (mixture 1) with the following characteristics: pH 4.65; salt 1.7° bé; lactic acidity 0.16%.

In addition, 2.5% by weight of alginate and 0.30% of guar gum was added to a commercially obtainable red pepper which has the following characteristics: pH 5.0; salt 0.29° bé; citric acidity 1.15%, and it was mixed until obtaining a homogenous mixture (mixture 2) with the following characteristics: pH 5.14; salt 0.29° bé; citric acidity 1.15%.

Both mixtures were then co-extruded simultaneously as a tube of circular section, a cylindrical tube of reconstituted olive stuffed with reconstituted pepper being obtained.

For gelatinization (outer gelatinization) said cylindrical tube was subjected to a 4% calcium chloride bath for 4 hours. Next the cylindrical tube was sliced, reconstituted pepper stuffed olive products being obtained, which were then preserved in stock brine solution of 8-9° bé of salt until its packaging and pasteurising.

The following table (Table 1) shows an overview of the composition of the reconstituted product described in Example 1.

TABLE 1
Composition in percentage by weight of the
total reconstituted olive product.

| | Mixture 1 | Mixture 2 |
|---|---|---|
| | (green olive) | (red pepper) |
| Green olives | 74.80% | |
| Red pepper | | 97.20% |
| Distilled water | 22.35% | |
| Alginate | 2.50% | 2.50% |
| Guar gum | 0.30% | 0.30% |
| Green colouring | 0.05% | |
| TOTAL | 100.00% | 100.00% |

Accordingly, while at least one embodiment of the present invention has been shown and described, it is to be understood that many changes and modifications may be made thereunto without departing from the spirit and scope of the invention as defined in the appended claims.

1. Process for preparing a reconstituted product comprising olive and pepper characterised in that it comprises the following steps:
a) grinding the starting olive until obtaining a homogenous mass of ground olive,
b) adding water, alginate and guar gum to the ground olive of step a) and mixing until obtaining a homogenous mixture 1 (mixture 1),
c) adding alginate and guar gum to ground and strained natural pepper, and mixing until obtaining a homogenous mixture 2 (mixture 2),
d) co-extruding mixtures 1 and 2 simultaneously an outer tube of mixture 1 with the inner space stuffed with mixture 2 being obtained,
e) gelatinization of the stuffed tube obtained in step d) by means of calcium salt bath, and
f) slicing the gelatinized stuffed tube obtained in step e).

2. Process according to claim 1, wherein the starting olive is green olive and its content is between 60% and 75% by weight of mixture 1.

3. Process according to claim 1, wherein a natural food colouring is added in step b).

4. Process according to claim 1, wherein the simultaneous co-extrusion is carried out in a way that the diameter of the inner portion is approximately half of the diameter of the outer portion.

5. Process according to claim 1, wherein step e) is carried out in a 4% calcium chloride bath.

6. Process according to claim 1, which comprises a packaging step and a temperature treatment step by pasteurising, sterilising or IQF freezing after step f).

7. Reconstituted food product obtainable according to claim 1.

8. Reconstituted food product according to claim 7 for its use in food industry, particularly in pizza toppings, salads, pastas, bakery products, pastry products, ready-cooked meals and snacks.
